(19) United States
(12) Patent Application Publication
(10) Pub. No.: US 2013/0036180 A1
(43) Pub. Date: Feb. 7, 2013

(54) SYSTEM AND METHOD FOR PRESENTING MULTILINGUAL CONVERSATIONS IN THE LANGUAGE OF THE PARTICIPANT

(71) Applicants: George Edward Deren, Milton, MA (US); Anna Victoria Chavez, Irving, TX (US); John Rooff, Austin, TX (US); Ken Satkunam, Fargo, ND (US); Dave Polcaro, Boston, MA (US); Tim Bourgeois, Boston, MA (US)

(72) Inventors: George Edward Deren, Milton, MA (US); Anna Victoria Chavez, Irving, TX (US); John Rooff, Austin, TX (US); Ken Satkunam, Fargo, ND (US); Dave Polcaro, Boston, MA (US); Tim Bourgeois, Boston, MA (US)

(73) Assignee: SENTRYBLUE GROUP, INC., WILMINGTON, DE (US)

(21) Appl. No.: 13/566,263

(22) Filed: Aug. 3, 2012

Related U.S. Application Data
(60) Provisional application No. 61/514,712, filed on Aug. 3, 2011.

(51) Int. Cl. G06F 15/16

(52) U.S. Cl. 709/206

(57) ABSTRACT

A computer-implemented method of providing real time translation of a conversation and presenting additional content, typically advertising related to the conversation or other conversations related to the topic of the present conversation.

### CROSS REFERENCE TO RELATED APPLICATION

This application claims priority under 35 U.S.C. §119(e) to U.S. Provisional Patent Application Ser. No. 61/514,712, filed Aug. 3, 2011 entitled SYSTEM AND METHOD FOR PRESENTING MULTILINGUAL CONVERSATIONS IN THE LANGUAGE OF THE PARTICIPANT.

### BACKGROUND OF THE INVENTION

1. Field of the Invention

The disclosed and claimed concept relates to presenting a conversation in multiple languages in the language of each participant and, more specifically, to a method of presenting a conversation in the language of each participant as well as additional content in the language of each participant.

2. Background Information

Social networking sites and similar Internet sites allow for conversations between multiple parties. There are many types of interfaces, but simple and common interfaces typically include a window having a title, an input field and, initially, an empty conversation field, i.e. an empty space. Participants in the conversation typically communicate by typing a message in the input field. This message appears in the empty space either while being typed or after the participant enters the message, i.e. after typing the message and pressing the return key. When a participant's message appears, the message is typically preceded by the user's name or username. This system works well so long as participants communicate in the same language.

Further, such conversations present an opportunity for commercial activity. That is, when such a conversation is occurring, the participants' attention is focused on a monitor. In this situation, it is easy to present advertising to the participants. To date, however, there has not been a method of analyzing the conversation to determine what advertising would be relevant to the conversation. This is especially true when the participants are using different languages.

### SUMMARY OF THE INVENTION

The disclosed and claimed concept relates to a computer-implemented method of providing real time translation of a conversation and presenting additional content, typically advertising related to the conversation or other conversations related to the topic of the present conversation. Each participant to the conversation has a computer that is in communication with an electronic network such as, but not limited to, the Internet. Each participant's computer is structured to execute a set of instructions whereby a conversation may occur. Generally, these instructions present an interface on the participant's monitor having at least an input field and a conversation field as well as instructions for providing input from an input device to the input field. The instructions are further structured to communicate with the electronic network. The instructions may be stored in the participant's computer or may be incorporated within a web page viewable by the participant's Internet browser. The sets of instructions may be identified as modules. The modules are structured to perform the steps associated with the method. The modules may be incorporated into one large set of instructions or may be divided into multiple cooperative sets of instructions.

The method includes the steps of providing access to the first and second participant to at least one conversation hosted on a computer, presenting the conversation individually to each participant, each presentation of the conversation being in each participant's selected language, allowing an active participant to contribute a new message to the conversation in the active participant's selected language, and presenting the new message individually to each participant, each presentation of the new message being in each participant's selected language.

### BRIEF DESCRIPTION OF THE DRAWINGS

A full understanding of the invention can be gained from the following description of the preferred embodiments when read in conjunction with the accompanying drawings in which:

FIG. 1 is a schematic of multiple participants in communication over an electronic network.

FIG. 2 is a schematic of the user interface presented to a participant.

FIG. 3 is a schematic of an alternate user interface presented to a participant.

FIGS. 4A-4B are a flow chart representing the steps of the method.

### DESCRIPTION OF THE PREFERRED EMBODIMENTS

With the advent of instant messaging, text messaging (“texting”), and other such forms of electronic communication, the meaning of the word “conversation” has expanded. That is, two or more parties may use a cellular telephone to text an entire series of communications rather than simply having an oral conversation with each other. Thus, in modern usage, and as used herein, a “conversation” specifically includes a written exchange of information over an electronic communication network

Thus, a “conversation,” unlike an oral conversation, may be easily stored and joined by new participants or resumed at a later time with the same participants, new participants, or a mixture thereof. Accordingly, the following convention will be used to identify messages in a “conversation.” The “conversation” includes at least one message. The conversation begins with an “initial message.” Thus, at the start of a conversation, the conversation's at least one message is the initial message. Any message subsequent to the initial message is a “new message.” Thus, after the initial message and one or more new messages, the “conversation” is the initial message and all new messages.

As used herein, a “computer” is a device structured to process data having at least one input device, e.g. a keyboard, and at least one output device, e.g. a display, a graphics card, a communication device, e.g. an Ethernet card, permanent memory, e.g. a hard drive, temporary memory, i.e. random access memory, and a processor, e.g. a programmable logic circuit. The “computer” may be a traditional desktop unit but also includes cellular telephones, tablet computers, laptop computers, as well as other devices, such as gaming devices that have been adapted to include components such as, but not limited to, those identified above.

As used herein, “permanent memory” means a computer readable storage medium and, more specifically, a computer readable storage medium structured to record information in a non-transitory manner. Thus, “permanent memory” is limited to non-transitory tangible media.

As used herein, “real time” means execution such that there is no significantly noticeable delay or inconvenient delay experienced by the end user.

As used herein, a “keyword” is a word having one or more associated concepts. The keyword and the associated concepts are stored in a keyword database. For example, the keyword “travel” may have associated concepts such as “hotel,” “rental,” “airline,” etc.

As used herein, “translate” means to convert a word or other language element from one language to another. Further, as used herein, “interpret” means to translate concepts related to words or other language elements. For example, the words “Romeo and Juliet” as proper names would “translate” as “Romeo and Juliet” but may be “interpreted” as “star-crossed lovers,” “foolish teenagers,” etc. Further, words that are in the same language may be “interpreted.” For example, a participant in England may use the word “lift” in reference to an elevator. This word may be “interpreted” for an English speaking participant in the United States as “elevator.”

As used herein, “stored in the permanent memory” means that a module of executable code or other data, e.g. a multi-language translation database, has become functionally and structurally integrated into the storage medium.

As used herein, “presented” when used in relation to an interface means that the interface 30 is shown on a display 9, as described below. That is, data is converted to an image, typically within the computer's graphic card, and shown on the display 9. It is further noted that, as the purpose of a computer-implemented method of providing multi-language communication is to allow the participants in the conversation engage in the conversation, and as that may only be accomplished by having the participants see the translated conversation. Thus, as used herein, “presenting” a conversation is not an insignificant extra solution activity following the act of translating the conversation.

As used herein, “mechanical audio output” means an audio output that is created from an electronic source, such as, but not limited to, text-to-speech. That is, a sound, such as, but not limited to, human speech, that is converted to a digital format then re-converted to audio is not a “mechanical audio output.”

Initially it is noted that each participant 11, 13, 15 in a conversation communicates in a “selected” language. The identification of the participant's selected language is stored as part of that user's account or profile, discussed below. Typically, the participant's 11, 13, 15 selected language is their native language, however, participants whose native language is less known language may select a different non-native language in which to communicate. For example, a participant who speaks Navajo as a primary language and English as a second language may choose to communicate in English. It is noted that, as shown, each participant 11, 13, 15 is associated with a different selected language; it is understood that the participants 11, 13, 15 shown in the figure may represent multiple participants who speak the associated selected language.

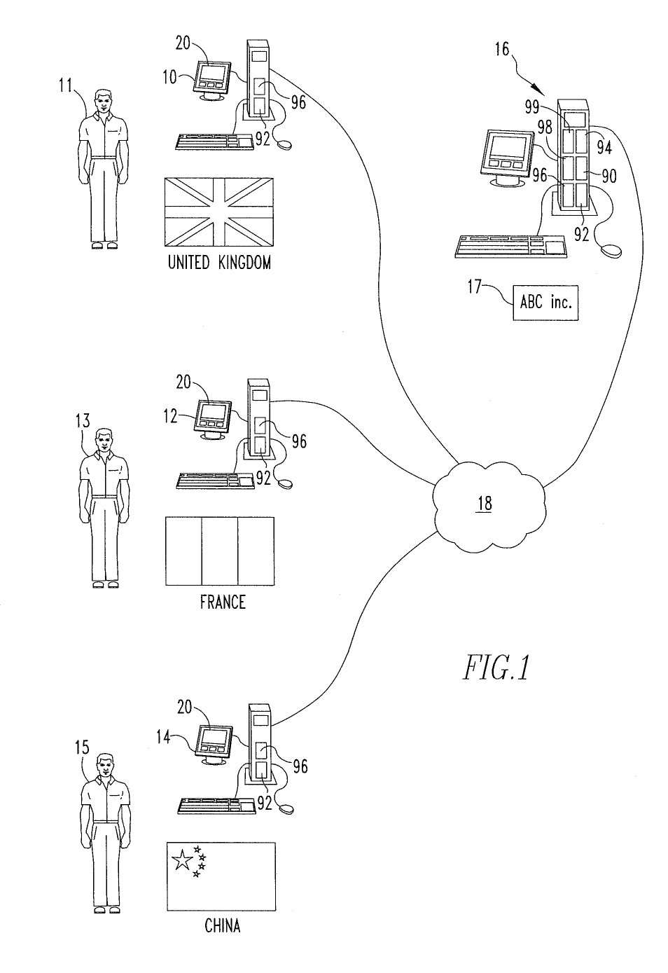

As shown in FIG. 1, the disclosed method provides for a multi-language communication between at least a first and second participant 11, 13, wherein each participant communicates in a selected language wherein each participant's 11, 13 selected language is different from the other participant's 11, 13 selected language. The method utilizes a plurality, or system, of computers 10, 12, 14, 16 in communication with an electronic network such as, but not limited to, the Internet 18. Each computer 10, 12, 14, 16 has an associated display 9 upon which an interface 30, discussed below, is shown. Each participant 11, 13, 15 operates a computer 10, 12, 14 except for one computer 16 that is operated by the service provider 17. That is, the service provider 17 operates a computer 16 hosting the service which is, preferably, accessed as a website 20 having a conversation interface 30, as discussed below. The service provider's computer 16 may be, and preferably is, a server. Further, it is noted that the service provider's computer 16 includes a translation module 98 having a multi-language translation database 7 either, or both, of which are stored in permanent memory 94.

The translation module 98 and multi-language translation database 97 are structured to translate and interpret conversations between selected languages. Further, there is a stored conversation module 99 having each conversation stored in permanent memory 94. Any or all conversations stored in the stored conversation module 99 may be encrypted. The stored conversation module 99 includes the conversation as input by each participant 11, 13, 15 as well as the conversation as translated. For example, if a conversation is occurring with the first participant's 11 selected language being English, the second participant's 13 selected language being French and the third participant's selected language being Chinese, then the each participant's 11, 13, 15 original input is stored in each participant's selected language, and, messages from each participant 11, 13, 15, as translated into the other participant's selected languages are also stored. Thus, it would be possible to view the conversation in any of the selected languages or to view the conversation as originally input, i.e. in the three selected languages. Further, a combination view may also be provided. That is, the conversation as translated into one selected language may be presented along with the input in another participant's selected language. Thus, bilingual participants could read the conversation in both languages. The participants 11, 13, 15, preferably, use an Internet browser to communicate with the Internet 18 and to be placed in communication with a provider's website 20. The provider's website 20 may include well known options such as sign-in/password interface, account management options, etc. After the participants 11, 13, 15 have signed in/logged on, the user is presented with a conversation interface 30. One option associated with each account is the “selected language” as noted above. Further, as not all languages may be translatable, participants 11, 13, 15 may be limited to a limited number of “selected languages” As is known, all languages that may be chosen as a “selected language” may be presented in a list or drop-down menu, e.g. as part of the account management options or as part of a conversation interface 30.

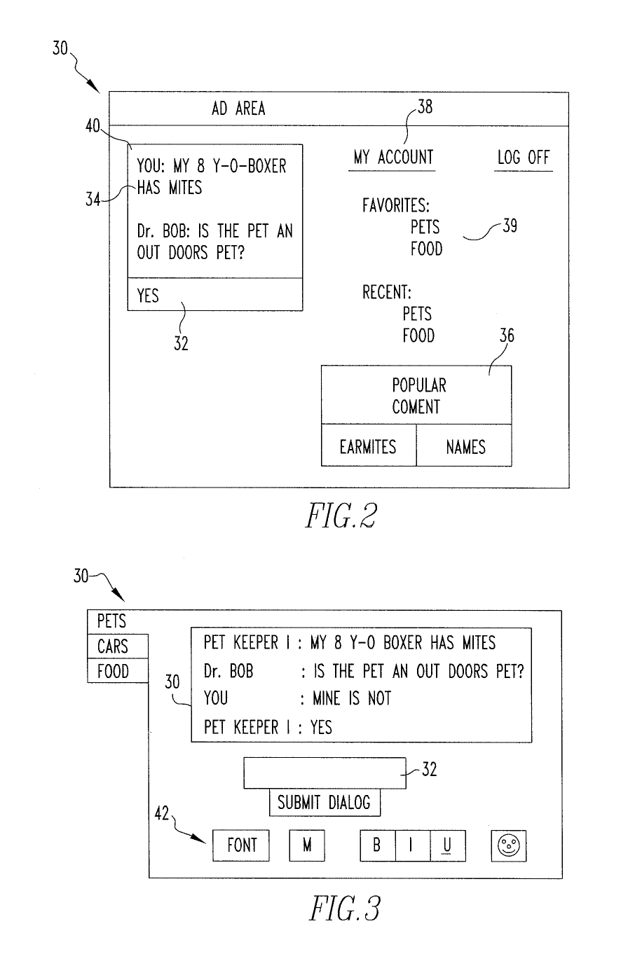

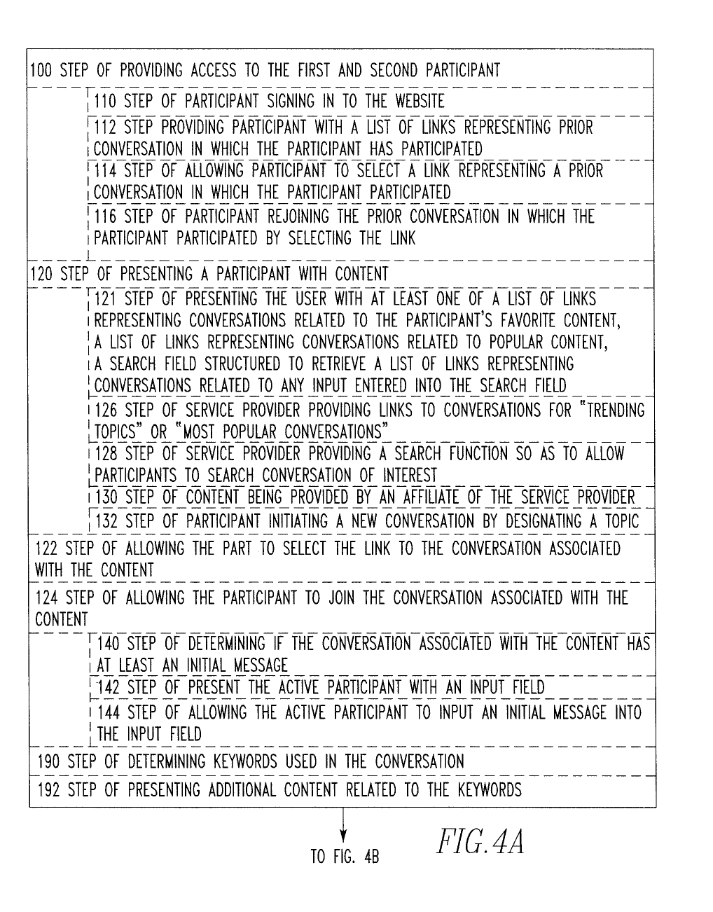

The conversation interface 30, shown in FIG. 2, includes a number of discrete portions including, but not limited to, an input field 32, a conversation field 34, and an additional content window 36. The interface 30 may include other portions such as, but not limited to, links to the user's account information 38, user's history 39, etc. As shown in FIG. 3, the interface 30 may be presented in a different manner structured to emphasize selected portions. That is, as shown, in an alternate form of the interface 30 the input field 32 and conversation field 34 may be presented in a much larger format. Further, the user interface 30 may present various buttons 42 structured to allow the participants 11, 13, 15 to manipulate the presentation of text entered into the conversation field, as discussed below. The buttons 42 may allow the participants 11, 13, 15 to alter aspects of the text such as, but not limited to, the font, size, characteristics, e.g. bold text, italic text, etc. Further, it is understood that when something is “presented” to a participant 11, 13, 15, the presentation, preferably, occurs on the user interface 30 as an image. The presentation may, however, include, or be limited to, mechanical audio output. For example, it is known to convert text into a simulated speech output corresponding to the text.

Before discussing the specific steps of the method, it is noted that many conversations are joined while in progress and that the participants in a conversation may change over time. That is, a typical conversation may progress as follows. A conversation field 34 is, preferably, identified by a title. As discussed below, and among various ways by which a conversation may be started, content may be provided by an affiliate (not shown) of the service provider 17; for example, a news service may provide a story regarding a politician. That content may provide a link, i.e. a hyperlink, as is known, to the service provider's website 20 and further to a specific conversation. In this instance, i.e. a conversation based on an article, the conversation would be presented in a conversation field 34 identified by the article's title. Other than the first participant 11 in the conversation, all other participants 13, 15 will join the conversation in progress. That is, the first participant 11 provides an initial message 40 in their selected language. A second participant 13 may follow the same link, i.e. the link from the affiliate, to the conversation. When this occurs, the conversation is translated into the second participant's selected language and presented to the second participant 13. The second participant 13 may then add a new message to the conversation. The first and second participants 11, 13 may continue the conversation by adding messages.

Subsequently, the third participant 15 joins the conversation. At that time, the conversation, i.e. all messages, are translated into the selected language of the third participant 15. The conversation may occur in real time, or may occur over an extended period of time. Thus, one of the original participants 11, 13 may have disengaged from the conversation, e.g. logged off the website 20, by the time the third participant 15 joins the conversation. The conversation is translated into any selected language of a participant 11 that has been a part of the conversation even after that participant 11 disengages from the conversation. This allows other participants using the selected language of that participant 11 to join the conversation and/or allows the original participant 11 to rejoin the conversation.

Generally, a conversation is presented in the conversation window 34 by showing the participant's name, typically a username or other pseudonym, and the participant's message adjacent thereto. Different participant's messages may be displayed in different colors so as to distinguish separate messages, however, as there may be many participants in a conversation, any color may be reused for multiple participants 11, 13, 15. Further, additional information may be presented, e.g. the country or selected language of the participant 11. The display of such additional information may be controlled by the participant in via the account management options. As is known, the conversation may be presented in various formats. For example, the conversation may be presented with the initial message on top and subsequent messages displayed below, or, the conversation may be presented with the newest message at the top of the window. Regardless of the format, when the conversation field 34 fills up, a scroll bar is provided within the conversation field 34 to allow the participant 11 to move forward and backward in the conversation.

Further, a participant 11, 13, 15 may have more than one conversation fields 34 open at one time. The different conversations may be presented in any known format. For example, the conversation fields 34 may be represented, as shown, by tabs associated with each conversation and wherein only an active tab/conversation presented in full with the other tabs/conversations limited to their title only. With this general description of conversations and the presentation thereof in mind, the method is performed as follows.

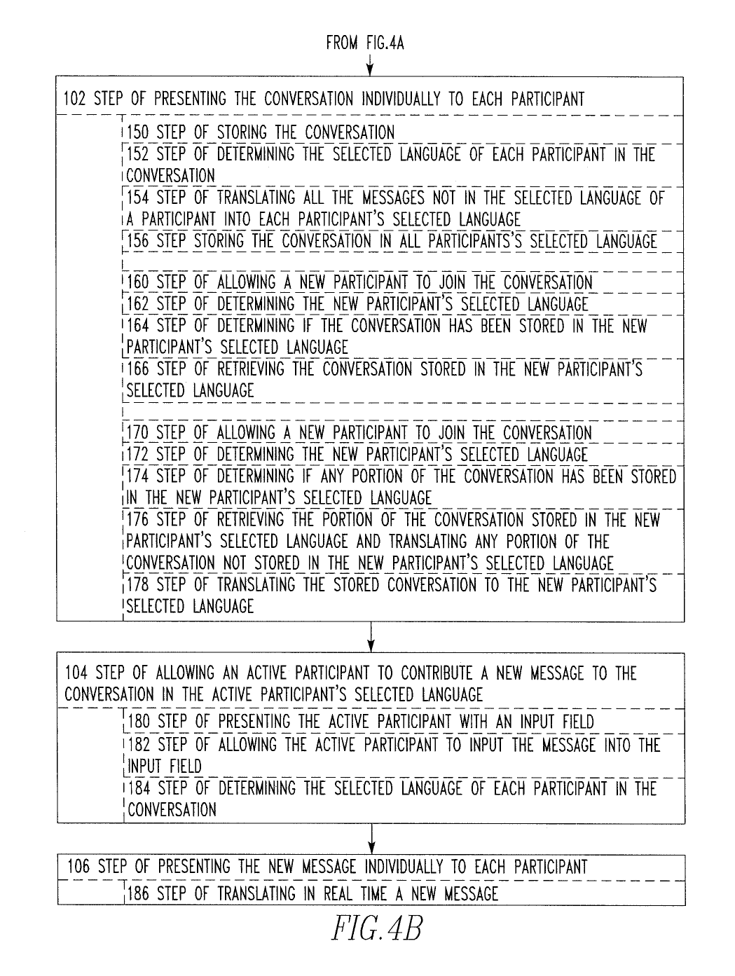

As shown in FIGS. 4A-4B, the method performed by the service provider 17 via the website 20 includes the steps of providing 100 access to the first and second participant 11, 12, to at least one conversation hosted on a computer 10, 12, presenting 102 the conversation individually to each participant 11, 12, each presentation of the conversation being in each participant's selected language, allowing 104 an active participant 11 to contribute a new message to the conversation in the active participant's selected language, and presenting 106 the new message individually to each participant 11, 13, each presentation of the new message being in each participant's selected language. It is noted that the “active” participant is the participant presently adding a message to the conversation. There may be multiple active participants 11, 13, 15 at a given time, but the messages are, preferably, presented in the order received by the service provider 17. It is further noted that, in an exemplary embodiment, the conversation is related to a specific topic or other content. That is, the conversation is initiated in response to existing content located on a website 30.

The step of providing 100 access to the first and second participant to at least one conversation hosted on a computer 16 is, preferably, initiated by having the participant 11 sign-in 110 to the website 30. The step of signing-in 110 does not have to occur, however. For example, a participant 11 may have the sign in information stored on their computer 10 and automatically uploaded to the website 20 thereby bypassing the sign in step, as is known, or, a participant 11 may be allowed to comment, i.e. leave messages, anonymously. When the participant 11 signs in, the participant is provided 112 with a list of links representing content or prior conversations in which the participant 11 has participated. The participant is then allowed 114 to select a link representing a prior conversation in which the participant participated. The participant may rejoin 116 the prior conversation in which the participant participated by selecting the link. When the participant rejoins 116 the conversation, the conversation interface displays a conversation field 34 presenting the conversation.

The step of providing 100 access to the first and second participant to at least one conversation hosted on a computer may also occur by, i.e. include the steps of, presenting 120 a participant with content, the content including a link to a conversation associated with the content, allowing 122 the participant to select the link to the conversation associated with the content, and allowing 124 the participant to join the conversation associated with the content. The content may be provided by the service provider 17. For example, the service provider 17 may provide 126 links to conversations for “trending topics” or “most popular conversation.” Alternatively, the service provider 17 may provide 128 a search function so as to allow participants to search conversations of interest. That is, a search field (not shown) is provided and, after a participant 11 has input a search term(s) and the search performed, a list of links to the relevant conversations is provided (not shown). Alternately, the content may be provided 130 by an affiliate of the service provider 17. For example, as described above, a third party news generator may provide a web page having content, e.g. a news report, as well as a link to a conversation on a web page about a certain event or person. Alternatively, a participant 11 may initiate 132 a new conversation by designating a topic, i.e. a title, and providing the initial message on the topic. As noted above, a conversation field 34 is preferably identified by a title associated with the content. Thus, the step of presenting 120 a participant with content may include presenting 121 the user with at least one of: a list of links representing conversations related to the participant's favorite content, a list of links representing conversations related to popular content, or a search field structured to retrieve a list of links representing conversations related to any input entered into the search field.

If a participant 11 is the first person to leave a message in the conversation that participant 11 is, at that moment, the active participant and the step of allowing 124 the participant to join the conversation associated with the content includes the steps of: determining 140 if the conversation associated with the content has at least an initial message, if not, presenting 142 the active participant with an input field; and allowing 144 the active participant to input an initial message into the input field.

The step of presenting 102 the conversation individually to each participant 11, 13, each presentation of the conversation being in each participant's selected language requires the translation of any message not in the participant's selected language. The translation is performed by the translation module 96. Thus, the step of presenting 102 the conversation individually to each participant 11, 13, each presentation of the conversation being in each participant's selected language includes the steps of storing 150 the conversation in permanent memory 94, determining 152 the selected language of each participant in the conversation, if any message in the conversation is not in the selected language of a participant, translating 154 all the messages not in the selected language of a participant into each participant's selected language, and storing 156 the conversation in the all participants' selected languages. It is noted that, as participants have identified and stored a selected language, the determination 152 of the selected language of each participant in the conversation is easily accomplished by analyzing the participant's profile.

Further, participants who have selected a language that is not currently being used in a conversation may join the conversation. Thus, the step of presenting 102 the conversation individually to each participant 11, 13, each presentation of the conversation being in each participant's selected language may also include the steps of: allowing 160 a new participant to join the conversation, determining 162 the new participant's selected language, determining 164 if the conversation has been stored is the new participant's selected language; and, if so, retrieving 166 the conversation stored in the new participant's selected language.

If this method is followed, any participant 11, 13, 15 should be presented with the conversation in their selected language. There may, however, be instances when the translation of an entire conversation into a participating selected language has not occurred. For example, if the second participant 13 disengages from a conversation and the translation of the conversation into that participant's selected language may be suspended. If the another participant having the same selected language as the second participant 13 joins the conversation, the portion of the conversation that occurred after the second participant 13 left the conversation and before the new part must be translated. If this situation arises, the step of presenting 102 the conversation individually to each participant 11, 13, each presentation of the conversation being in each participant's selected language may also include the steps of: allowing 170 a new participant to join the conversation, determining 172 the new participant's selected language, determining 174 if any portion of the conversation has been stored in the new participant's selected language, if so, retrieving 176 the portion of the conversation stored in the new participant's selected language and translating any portion of the conversation not stored in the new participant's selected language, and if not, translating 178 the stored conversation to the new participant's selected language. It is noted that, in this context, the “new” participant may be a former participant 11, 13, 15 rejoining the conversation. That is, the steps set forth in this paragraph allow for a partially translated conversation to be completely translated before presenting the conversation to a participant 11, 13, 15 joining the conversation while using a selected language that is not presently part of the translated conversation.

Alternatively, a conversation may always be translated into any selected language once any participant 11, 13, 15 uses that selected language. For example, assume a conversation between a first participant 11 having English as a selected language and a second participant 13 having French as a selected language had been occurring. As each of these participants 11, 13 added messages to the conversation, the messages would be translated into either English or French in real time (as described below) and then stored. When a third participant 15 having Chinese as a selected language joins the conversation, it is easily determined that the conversation is not in that participant's selected language and the stored conversation, i.e. all the stored messages, would be translated into Chinese and presented to the third participant 15. Thereafter, all messages added to the conversation would be translated into the three selected languages, and the conversation stored in those languages, regardless of whether the participants remained active in that conversation.

The step of allowing 104 an active participant 11 to contribute a new message to the conversation in the active participant's selected language includes the steps of presenting 180 the active participant with an input field, allowing 182 the active participant to input the new message into the input field, and determining 184 the selected language of each participant in the conversation. The step of presenting 106 the new message individually to each participant 11, 13, each presentation of the new message being in each participant's selected language includes the step of translating 186 in real time the new message into all other the participants' languages. It is noted that, in the preferred embodiment, the messages are stored in permanent memory 94 as soon as the messages are input or translated. Thus, the entire conversation is, preferably stored in permanent memory 94. Further, each message may be encrypted as it is stored. As such, the conversation may be encrypted.

Further, the presentation of conversations allows the service provider 17 to provide additional content related to the conversation. The additional content may be content such as, but not limited to, links to similar conversations or advertisements related to the conversation. The determination of what additional content is related is determined by analyzing the conversation for related keywords and then presenting additional content related to those keywords. Thus, the step of presenting 102 the conversation individually to each participant, each presentation of the conversation being in each participant's selected language may include the steps of: determining 190 keywords used in the conversation, and presenting 192 additional content related to the keywords.

The method set forth above is performed on a computer 10, 12, 14, 16 having a processor 90 structured to execute executable code and a plurality of modules 92 (computer elements shown schematically in FIG. 1) of executable code and/or data, including the translation module 98 noted above, structured to be executed on the processor 90 of at least one computer 10, 12, 14, 16. It is noted that the processor 90 may be either a “general purpose processor” 90A, meaning a computer, a “defined purpose processor” 90B meaning a device with a defined purpose, for example, a translation device which is limited to performing a specific task; in this instance providing the interface 30 and performing the method set forth herein, or a “temporarily defined purpose processor” 90C. A “defined purpose processor” is a processor wherein the programming is fixed therein, i.e. the programming is not structured to be changed. A “temporarily defined purpose processor” is similar to a “defined purpose processor” but includes semi-fixed programming, such as, but not limited to, programming stored in “flash” memory, RAM or other non-permanent memory. Unless otherwise noted, all modules 92 shall be represented by the reference number “92.” It is understood that a module 92 may include a single file of executable code or a plurality of files. It is further understood that a module 92 may share files of executable code with other modules 92.

Further, it is noted that all “modules of executable code or data,” i.e. the modules 92 98, 99, must be executed, or read, by a computer 10, 12, 14, 16. The computers 10, 12, 14, 16 each have a permanent memory 96. The modules 92, 98, 99 may be located on the service provider's computer 16, that is stored in the permanent memory 96 of the service provider's computer 16, or may be partially stored on one or more participant's computers 10, 12, 14, that is, the modules 92, 98, 99 may be stored in the permanent memory 96 of one or more participant's computers 10, 12, 14. Typically, the modules 92, 98, 99 are stored in the permanent memory 96 of the service provider's computer 16 and the interface 30 is presented to the other participants computers 10, 12, 14 via the electronic network 18 as a website 20 shown in a browser.

At least one module 92 in the plurality of modules 92 is structured to perform each of the steps set forth above. Thus, for example, the plurality of modules 92 include a module 92 structured to provide access to the first and second participant to at least one conversation hosted on a computer, a module 92 structured to present the conversation individually to each participant, each presentation of the conversation being in each participant's selected language, a module 92 structured to allow an active participant to contribute a new message to the conversation in the active participant's selected language, and a module 92 structured to present the new message individually to each participant, each presentation of the new message being in each participant's selected language. Thus, it is understood that for each step identified above (as well as any step shown in the figures), there is an associated module 92 stored in the permanent memory 94 and structured to perform that step. Therefore, the computer-implemented method described above is, at some time, a computer readable medium for storing computer executable code structured to perform the method and has not been put into effect as one or more transitory propagating signals. Thus, is understood that a computer readable medium for storing a computer program includes modules 92, or code, for performing each of the steps described above.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A computer-implemented method of providing multi-language communication between at least a first and second participant, each said participant communicating in a selected language wherein each participant's selected language is different from the other participant's selected language, said method comprising the steps:
providing access to said first and second participant to at least one conversation hosted on a computer;
presenting said conversation individually to each said participant, each said presentation of said conversation being in each participant's selected language;
allowing an active participant to contribute a new message to said conversation in said active participant's selected language; and
presenting said new message individually to each said participant, each said presentation of said new message being in each participant's selected language.

2. The computer-implemented method of claim 1 wherein said step of providing access to said first and second participant to at least one conversation hosted on a computer includes the steps of:
providing a participant with a list of links representing prior conversations in which the participant participated;
allowing said participant to select a link representing a prior conversation in which the participant participated; and
rejoining said prior conversation in which the participant participated.

3. The computer-implemented method of claim 1 wherein said step of providing access to said first and second participant to at least one conversation hosted on a computer includes the steps of:
presenting a participant with content, said content including a link to a conversation associated with said content;
allowing said participant to select said link to said conversation associated with said content;
allowing said participant to join said conversation associated with said content.

4. The computer-implemented method of claim 3 wherein said step of allowing said participant to join said conversation associated with said content includes the steps of:
determining if said conversation associated with said content has at least an initial message;
if not, presenting said active participant with an input field; and
allowing said active participant to input an initial message into said input field.

5. The computer-implemented method of claim 3 wherein said step of presenting a participant with content includes the steps of:
presenting the user with at least one of: a list of links representing conversations related to said participant's favorite content, a list of links representing conversations related to popular content; a search field structured to retrieve a list of links representing conversations related to any input entered into said search field.

6. The computer-implemented method of claim 1 wherein said step of presenting said conversation individually to each said participant, each said presentation of said conversation being in each participant's selected language includes the steps of:
storing said conversation;
determining the selected language of each participant in said conversation;
if any message in said conversation is not in the selected language of a participant, translating all said messages not in the selected language of a participant into each said participants' selected language; and
storing said conversation in said all participants' selected languages.

7. The computer-implemented method of claim 6 wherein said step of presenting said conversation individually to each said participant, each said presentation of said conversation being in each participant's selected language includes the steps of:
allowing a new participant to join said conversation;
determining said new participant's selected language;
determining if said conversation has been stored is said new participant's selected language; and
if so, retrieving said conversation stored in said new participant's selected language.

8. The computer-implemented method of claim 7 wherein said step of presenting said new message individually to each said participant, each said presentation of said new message being in each participant's selected language includes the step of:
translating in real time said new message into all other said participants' languages.

9. The computer-implemented method of claim 6 wherein said step of presenting said conversation individually to each said participant, each said presentation of said conversation being in each participant's selected language includes the steps of:
allowing a new participant to join said conversation;
determining said new participant's selected language;
determining if any portion of said conversation has been stored is said new participant's selected language;
if so, retrieving said portion of said conversation stored in said new participant's selected language and translating any portion of said conversation not stored in said new participant's selected language; and
if not, translating said stored conversation to said new participant's selected language.

10. The computer-implemented method of claim 9 wherein said step of presenting said new message individually to each said participant, each said presentation of said new message being in each participant's selected language includes the step of:
translating in real time said new message into all other said participants' languages.

11. The computer-implemented method of claim 1 wherein said step of presenting said new message individually to each said participant, each said presentation of said new message being in each participant's selected language includes the step of:
translating in real time said new message into all other said participants' languages.

12. The computer-implemented method of claim 11 wherein said step of allowing an active participant to contribute a new message to said conversation in said active participant's selected language includes the steps of:
presenting said active participant with an input field;
allowing said active participant to input said new message into said input field; and
determining the selected language of each participant in said conversation.

13. The computer-implemented method of claim 1 wherein said step of presenting said conversation individually to each said participant, each said presentation of said conversation being in each participant's selected language includes the steps of:
determining keywords used in said conversation; and
presenting additional content related to said keywords.

14. A system for allowing multi-language communication between at least a first and second participant, each said participant communicating in a selected language wherein each participant's selected language is different from the other participant's selected language, each participant having a computer, said system comprising:
a computer having a processor structured to execute executable code and a plurality of modules of executable code structured to be executed on said processor;
said plurality of modules including:
a module structured to provide access to said first and second participant to at least one conversation hosted on a computer;
a module structured to present said conversation individually to each said participant, each said presentation of said conversation being in each participant's selected language;
a module structured to allow an active participant to contribute a new message to said conversation in said active participant's selected language; and
a module structured to present said new message individually to each said participant, each said presentation of said new message being in each participant's selected language.

15. The system of claim 14 wherein said module structured to present said new message individually to each said participant, each said presentation of said new message being in each participant's selected language is further structured to translating in real time a new message into all other said participants' languages.

16. The system of claim 14 further including a module structured to allow a new participant to join said conversation, determine said new participant's selected language, determine if said conversation has been stored is said new participant's selected language, and if so, retrieve, said conversation stored in said new participant's selected language.

17. The system of claim 14 further including a module structured to present a participant with content, said content including a link to a conversation associated with said content, allow said participant to select said link to said conversation associated with said content, and allow said participant to join said conversation associated with said content.

18. The system of claim 14 further including a module structured to present the user with at least one of: a list of links representing conversations related to said participant's favorite content, a list of links representing conversations related to popular content; a search field structured to retrieve a list of links representing conversations related to any input entered into said search field.

19. The system of claim 14 further including a module structured to store said conversation, determine the selected language of each participant in said conversation, translate all said messages not in the selected language of a participant into each said participants' selected language, and store said conversation in said all participants' selected languages.

20. The system of claim 14 further including a module structured to allow a new participant to join said conversation, determine said new participant's selected language, determine if said conversation has been stored is said new participant's selected language, and, if so, retrieving said conversation stored in said new participant's selected language.
